(19) United States
(12) Patent Application Publication
(10) Pub. No.: US 2022/0114113 A1
(43) Pub. Date: Apr. 14, 2022

(54) COMMAND ORCHESTRATION BETWEEN APPLICATIONS AND PERIPHERAL DEVICES

(71) Applicant: Hewlett-Packard Development Company, L.P., Spring, TX (US)

(72) Inventors: Endrigo Nadin Pinheiro, Spring, TX (US); Christopher Charles Mohrman, Spring, TX (US); Roger Benson, Spring, TX (US); Stephen Mark Hinton, Spring, TX (US); Syed Azam, Spring, TX (US)

(73) Assignee: Hewlett-Packard Development Company, L.P., Spring, TX (US)

(21) Appl. No.: 17/288,545

(22) PCT Filed: Jun. 20, 2019
(86) PCT No.: PCT/US2019/038204

§ 371 Date: Apr. 25, 2021

(51) Int. Cl. G06F 13/10; G06F 3/16

(52) U.S. Cl. CPC G06F 13/102; G06F 3/165

(57) ABSTRACT

An example of an apparatus includes an application engine to execute an application. The apparatus includes a first communication interface to communicate with a first peripheral device. The apparatus includes a second communication interface to communicate with a second peripheral device. The apparatus includes an orchestration engine in communication with the application engine, the first communication interface, and the second communication interface. The orchestration engine is to receive an application command from the application and to broadcast the application command to the first peripheral device and the second peripheral device. The orchestration engine is to receive a device command from the first peripheral device or the second peripheral device, wherein the device command is to control the application.

### BACKGROUND

Computers and other personal electronic devices may be used for communication between users. The manner by which users communicate may include telephony services, messaging services, conferencing services, and other collaborative methods. Some computers and personal electronic devices include applications that may combine methods of communication into a single application such as a unified communications client. To interact with the unified communications client, a computer or personal electronic device may interact with a peripheral device such as a microphone, a speaker, a headset, or other device capable. The peripheral device and the computer may also communicate directly with each other to provide functionality.

### BRIEF DESCRIPTION OF THE DRAWINGS

Reference will now be made, by way of example only, to the accompanying drawings in which:

FIG. 1 is a schematic representation of an example apparatus to orchestrate commands between an application and peripheral devices;

FIG. 2 is a schematic representation of another example apparatus to orchestrate commands between an application and peripheral devices;

FIG. 3 is a schematic representation of the example apparatus shown in FIG. 2 illustrating the flow of data from the communications engine;

FIG. 4 is a schematic representation of the example apparatus shown in FIG. 2 illustrating the flow of data to the communications engine from a peripheral device;

FIG. 5 is a schematic representation of the example apparatus shown in FIG. 2 illustrating the flow of data to the communications engine from another peripheral device;

FIG. 6 is a schematic representation of another example apparatus to orchestrate commands between an application and peripheral devices; and

FIG. 7 is a flowchart of an example of a method of orchestrating commands between an application and peripheral devices.

### DETAILED DESCRIPTION

Applications on personal computers or other personal electronic devices may be used as a communication device to allow users to communicate over great distances via the applications running on the personal computer. For example, a unified communications client may be used to provide communications via telephony services, messaging services, conferencing services, and other collaborative methods. The unified communications client may also send and receive commands to and from a peripheral device selected as a default device for a call, regardless of how many other devices are attached to the platform. However, modern personal computers and personal electronic devices may have more than one peripheral device capable of being used with a unified communications client. For example, a personal computer may have a headset with volume controls and keyboard with status indicators and buttons to control various functions within the unified communications client, such as volume, starting a call, joining two calls, or ending a call.

It is to be appreciated that the unified communications client is not particularly limited. In the present example, the unified communications client may be an application running on a personal computer that integrates services such as instant messaging (chat), presence information, voice (including IP telephony), mobility features (including extension mobility and single number reach), audio, web & video conferencing, fixed-mobile convergence (FMC), desktop sharing, data sharing (including web connected electronic interactive whiteboards), call control and speech recognition with non-real-time communication services such as unified messaging (integrated voicemail, e-mail, SMS and fax). Accordingly, the unified communications client provides an integrated interface for a user to communicate across multiple mediums.

Although some keyboards may be provided with a volume control, the keyboard acting as the non-default device will not be able to directly communicate with the unified communications client, such as through the protocols, such as a Human Interface Device protocol, used to communicate with the default peripheral device. The Human Interface Device protocol is a standardized protocol for an application running on a processor to interact with a compatible peripheral device. In particular, the Human Interface Device protocol provides standard commands that may be sent from the application directly to the peripheral device connected to the application. For example, the volume controls on the non-default device may adjust a system wide volume instead of the volume of the unified communications client such that other applications as well as the operating system may experience a blanket volume change. As another example, the unified communications client may have other software solutions where the unified communications client communicates with the non-default device via various drivers through the operating system instead of through a direct communication link, such as one provided by the Human Interface Device protocol. It is to be appreciated that using a software solution to communicate with a peripheral device via standard protocols introduces more latency as well as requires more resources from the computer system.

To increase user experience, an apparatus is provided with an orchestration engine to run on the system that keeps track of every peripheral device present in the system and its status. This tracking involves actively monitoring for the addition or removal of new devices. Also, the orchestration engine receives every user action that is taken on the peripheral devices, such as a button press on a peripheral device, or a voice command on another peripheral device, that corresponds to a command that is then sent to the unified communications client. The orchestration engine allows the end user to interact with a unified communication system via multiple peripheral devices. Additionally, the orchestration engine also listens for commands originating from the unified communications client and sent to a previously defined default peripheral device. The orchestration engine replicates the command from and sends it to the appropriate peripheral device, which may not be the default one previously attached to the unified communications client.

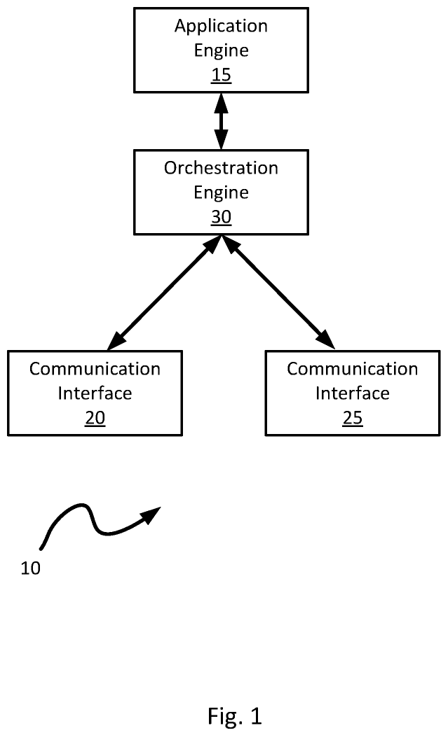

Referring to FIG. 1, an apparatus to orchestrate commands between an application and peripheral devices is shown at 10. The apparatus 10 may include additional components, such as various additional interfaces and/or input/output devices such as displays to interact with a user or an administrator of the apparatus 10. In the present example, the apparatus 10 includes an application engine 15, a first communication interface 20, a second communication interface 25, and an orchestration engine 30. Although the present example shows the application engine 15 and the orchestration engine 30 as separate components, in other examples, the application engine 15 and the orchestration engine 30 may be part of the same physical component such as a microprocessor configured to carry out multiple functions.

The application engine 15 is to execute an application. It is to be appreciated that the application is not particularly limited. For example, the application may be any application capable of communicating directly with a peripheral device. Direct communication with the peripheral device may allow the application to send commands directly to the peripheral device. In addition, direct communication with the peripheral device may allow the application to receive commands directly from input at the peripheral device.

As a specific example, the application engine 15 may be to execute a communications application, such as a unified communications client to provide users on separate electronic devices the ability to communicate with each other. For example, a first user may be operating a computer system with a communications application installed thereupon. The communications application may establish a communication link with a second user. In the present example, the second user may operate another device that is external to the apparatus 10. In addition, the external device of the second user may not have the same communications application installed on an electronic device. Instead, the second user may be using a regular telephone to carry out a communication link with the communications application of the first user. The regular telephone communication link may be a standard telephony service. Accordingly, the communications application of the first user may allow for a standard telephony communication line to be established with a second user on an external device.

Furthermore, in the present example, the application may be to establish a direct connection with the peripheral device. It may be assumed that the peripheral device is to be connected to the communications application running on the application engine 15 via the communication interface 20. A direct connection may mean a connection where the communications application may send commands or data directly to the peripheral device. In addition, the direct connection may allow the peripheral device to send commands or data directly to the application. The manner by which a direct connection is established is not particularly limited. For example, the communications application may communicate directly with the peripheral device using a protocol, such as a Human Interface Device protocol, which provides such direct communications between an application and a peripheral device. It is to be understood that by using the Human Interface Device protocol, the communications application may be able to send commands to the peripheral device without using the operating system. Accordingly, the Human Interface Device protocol may allow the peripheral device to communicate in a more efficient manner.

Continuing with the example above of a communications link between a unified communications client and a telephone, the peripheral device may be a headset having a microphone and a speaker. The headset may include a user input panel where a user may generate input to change the volume of the unified communications client, adding a participant to a telephone call, answering another incoming call, and/or switching screen sharing. Similarly, the unified communications client may send commands or data to the headset. For example, the unified communications client may send a status of the call to the headset, such as whether the unified communications client has been placed on hold, or if the call has been ended or answered.

The communication interface 20 is to communicate with a peripheral device. In particular, the communication interface 20 is to send commands and data to the peripheral device and to receive commands and data from the peripheral device. Continuing with the example above, the apparatus 10 may provide a user the ability to communicate with another user on an external device, such as a telephone. Accordingly, the communication interface 20 may be to communicate with a headset to facilitate a telephony communication. In the present example, the headset may include a microphone to receive audio data, such as a voice data, from a user. The headset may also include additional buttons or input mechanisms, such as a touch screen, to receive input to be received at the communication interface 20. In addition, the headset may include a speaker to generate audio output for the user. The headset may also include additional indicators or output mechanisms, such as a display screen, to generate output for the user via the communication interface 20.

The manner by which the communication interface 20 sends and receives data to and from the peripheral device is not particularly limited. In the present example, the communication interface 20 may be a wireless interface to communicate with the peripheral device over short range distances using ultra high frequency radio waves. In particular, the communication interface 20 may be to use a standard, such as Bluetooth. In other examples, the communication interface 20 may connect to the peripheral device via the Internet, or via a wired connection.

Returning to the present specific example, the communication interface 20 may be to communicate with a peripheral device, such as a headset, to establish a direct connection with the application executed by the application engine 15. The manner by which the direct connection is established is not particularly limited and may be in response to a triggering event. In the present example, the triggering event may be a user input received at the communication interface 20 from the peripheral device. For example, the user may press a button or provide a voice command to the headset. Continuing the example above, the application is a unified communication client and may receive a telephone call from an external device. Accordingly, the unified communication client may send data via the communication interface 20 to the headset. In response, the headset may generate output for the user. For example, the headset may ring or vibrate to indicate a telephony call is requested. In response, the user of the headset may depress a button to answer the telephony call. It is to be appreciated that the answering of the telephony call may be the triggering event to attach the headset connected via the communication interface 20 to the unified communications client via the Human Interface Device protocol.

The communication interface 25 is to communicate with another peripheral device. In particular, the communication interface 25 is to send commands and data to the peripheral device and to receive commands and data from the peripheral device. Continuing with the example above, the communication interface 25 may be to communicate another user interface device, such as a keyboard. The keyboard may include keys to receive input from the user. In addition to the standard keys on the keyboard, the keyboard may include specialty keys for interacting with the unified communications client, such as volume control keys and keys to handle telephony calls such as a button to answer a call or to hang-up on a call. The keyboard may also include additional indicators of a display screen to output data associated with a telephony call received from the application via the communication interface 25. The additional data to be received is not limited and may include timer data, call status data, caller identification information, and other data which associated with a telephony call.

The manner by which the communication interface 25 sends and receives data to and from the additional peripheral device is not particularly limited. In the present example, the communication interface 25 may be a wireless interface to communicate with the peripheral device over short range distances using ultra high frequency radio waves. In particular, the communication interface 25 may be to use a standard, such as Bluetooth. In other examples, the communication interface 25 may connect to the peripheral device via the Internet, or via a wired connection.

Returning to the present specific example, it is to be appreciated that the Human Interface Device protocol may be used to connect a single peripheral device and that additional devices are not supported. Therefore, since the communication interface 20 has already established a direct connection with the application running on the application engine 15 via the Human Interface Device protocol, a direct connection to the application cannot be established by the keyboard in communication via the communication interface 25 using the standard Human Interface Device protocol.

In the present example, the orchestration engine 30 is in communication with the application engine 15, and the communication interfaces 20 and 25. The orchestration engine 30 is to receive commands and data from the application running on the application engine 15 and to orchestrate the commands to the peripheral device connected to the apparatus via the communication interface 20 and to the peripheral device connected to the apparatus via the communication interface 25. In addition, the orchestration engine 30 is to receive commands and data from the peripheral device via the communication interface 20 and the second peripheral device via the communication interface 25. The orchestration engine 30 is to orchestrate the commands and data received via the communication interface 20 or the communication interface 25 to the application to control various features of the application.

Referring again to the example above, a headset is connected to the communication interface 20 and a keyboard connected to the communication interface 25. In this example, both the headset and the keyboards may have additional inputs and outputs for a unified communications client. The default device attached the unified communications client using the Human Interface Device protocol may be assumed to be the headset connected to the communication interface 20. During operation, the orchestration engine 30 is to intercept a command received from the unified communications client to a peripheral device via the Human Interface Device protocol. It is to be appreciated that the command from the unified communications client is directed to the headset via the communication interface 20. The orchestration engine 30 intercepts this command and forwards it to the keyboard via the communication interface 25 as well. For example, a command from the unified communications client may be to activate an indicator, such as an LED, a sound, a vibration, or a prompt on a display screen, to inform a user that there is an incoming telephone call. By sending the command to both the headset and the keyboard, both peripheral devices will generate output to the user. By contrast, in the absence of orchestration engine 30, the Human Interface Device command will not be received by the keyboard.

Similarly, the orchestration engine 30 is to intercept a command received from a peripheral device via the Human Interface Device protocol intended for the unified communications client. It is to be appreciated that the command may be received from the headset via the communication interface 20 or from the keyboard via the communication interface 25 even though the keyboard is not directly connected to the unified communications client via the Human Interface Device protocol. The orchestration engine 30 receives this command regardless of which peripheral device generated the command and forwards it to the unified communications client. For example, in response to a command from the unified communications client inform a user that there is an incoming telephone call, a user may use an “answer call” button on the keyboard to generate a command via the communication interface 25. The orchestration engine 30 receives the command and directs it to the unified communications client using the Human Interface Device protocol. By contrast, in the absence of orchestration engine 30, since the unified communications client is connected to the headset via the Human Interface Device protocol, the keyboard will not be able to send the Human Interface Device command to the unified communications client. Although alternative software solutions, such as building a backdoor to the unified communications client may also work, it is to be appreciated that by using and alternative route to send commands to the unified communications client involves additional layers and uses more customized software.

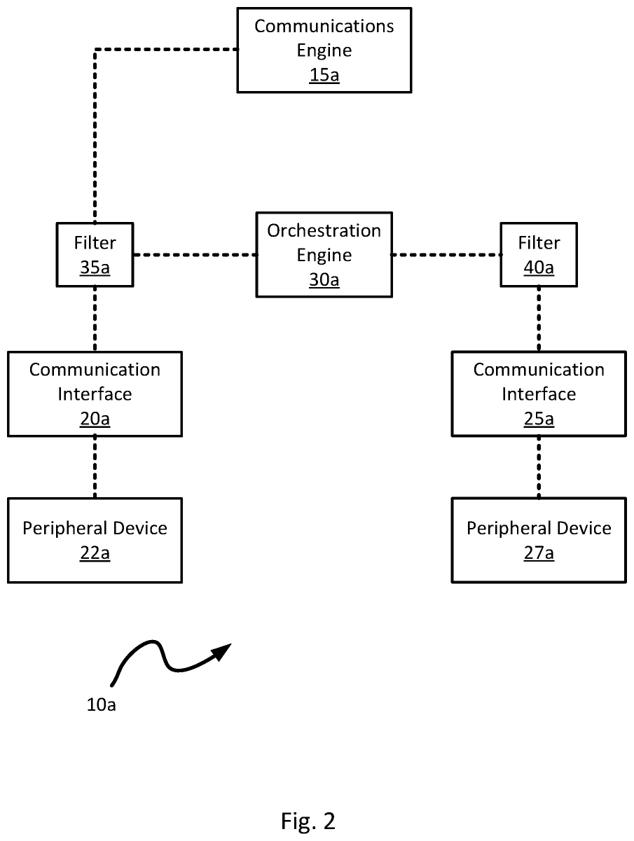

Referring to FIG. 2, another example of an apparatus to orchestrate commands between an application and peripheral devices is shown at 10a. Like components of the apparatus 10a bear like reference to their counterparts in the apparatus 10, except followed by the suffix “a”. In the present example, the apparatus 10a includes a communications engine 15a, a first communication interface 20a, a first peripheral device 22a, a second communication interface 25a, a second peripheral device 27a, an orchestration engine 30a, a first filter 35a, and a second filter 40a.

The communications engine 15a is to execute a unified communications client to provide users on separate electronic devices the ability to communicate with each other. For example, a first user may be operating a computer system with a unified communications client installed thereupon for the purpose of communication with another user on a separate computer system. In the present example, the second user may operate another device that is external to the apparatus 10a. In addition, the external device of the second user may or may not have the same unified communications client installed on the external device. Instead, the second user may be using a regular telephone to carry out a communication link with the unified communications client of the first user. The regular telephone communication link may be a standard telephony service. Accordingly, the unified communications client of the first user may allow for a standard telephony communication line to be established with a second user on an external device.

In the present example, the unified communications client establishes a direct connection with the peripheral device 22a via the communication interface 20a using a Human Interface Device protocol such that the peripheral device 22a may send and receive Human Interface Device commands with the unified communications client. The apparatus 10a further includes an additional peripheral device 27a is also compatible with the Human Interface Device protocol to operate with the unified communications client. Accordingly, the peripheral device 27a is to receive user input and generate commands directly for the unified communications client.

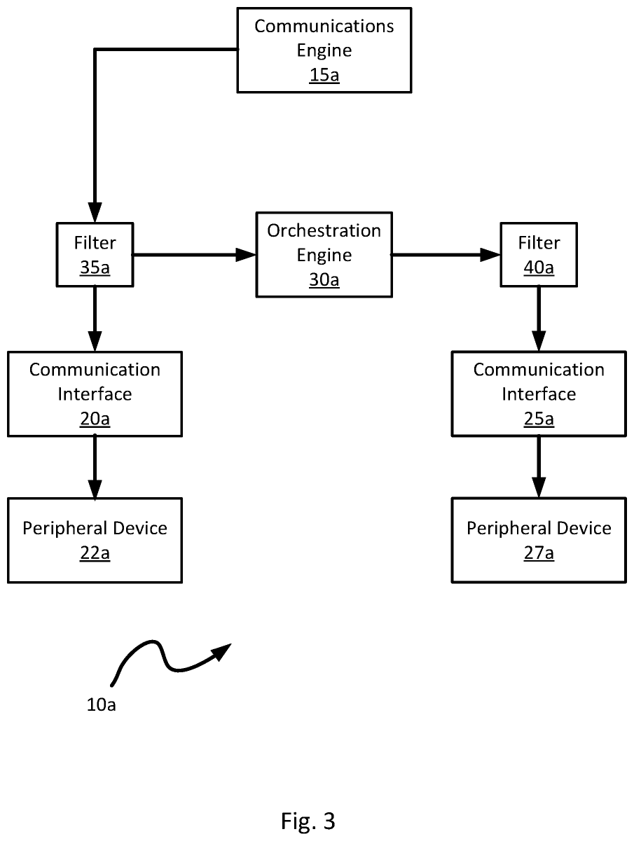

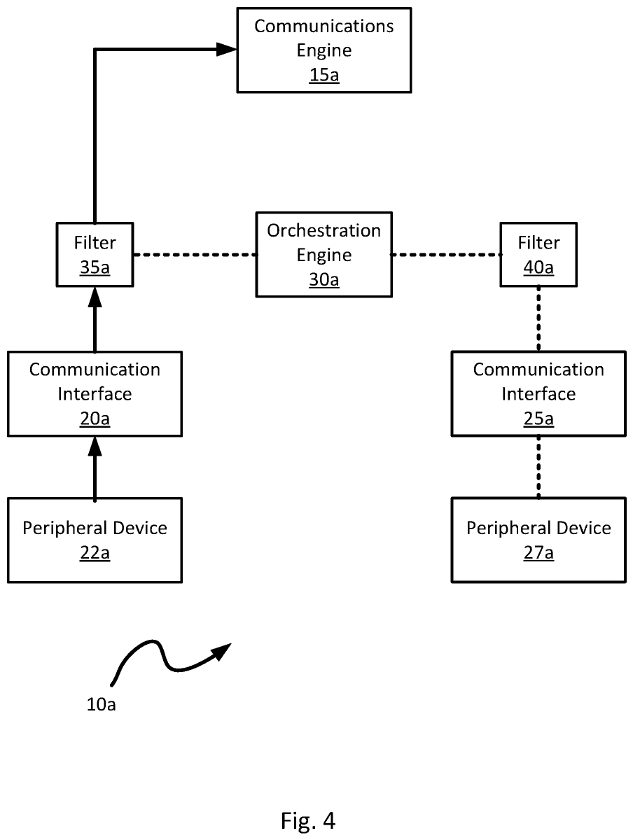

In the present example, the peripheral device 22a has the filter 35a installed. The filter 35a may be a driver that is to control the peripheral device 22a in general. Referring to FIG. 3, the filter 35a may intercept Human Interface Device commands that are inbound for the peripheral device 22a from the unified communications client. Upon intercepting the Human Interface Device command from the unified communications client, the filter 35a replicates the command and forwards it to the orchestration engine 30 which may forward it the peripheral device 27a. Accordingly, although the peripheral device 27a is not in communication with the unified communications client using the Human Interface Device protocols, the peripheral device 27a will receive the command in a similar manner as the peripheral device 22a. The peripheral device 27a will therefore be synchronized with the peripheral device 22a. For example, the peripheral device 27a and the peripheral device 22a may display the status of the unified communications client, such as whether a call is active or on hold. As another example, both of the peripheral device 27a and the peripheral device 22a may be used to receive user input, such as a volume control command or end call command, to control the unified communications client when synchronized. Since the peripheral device 22a is directly connected with the unified communications client, commands from the peripheral device 22a may pass through the filter to the communications engine 15a as shown in FIG. 4.

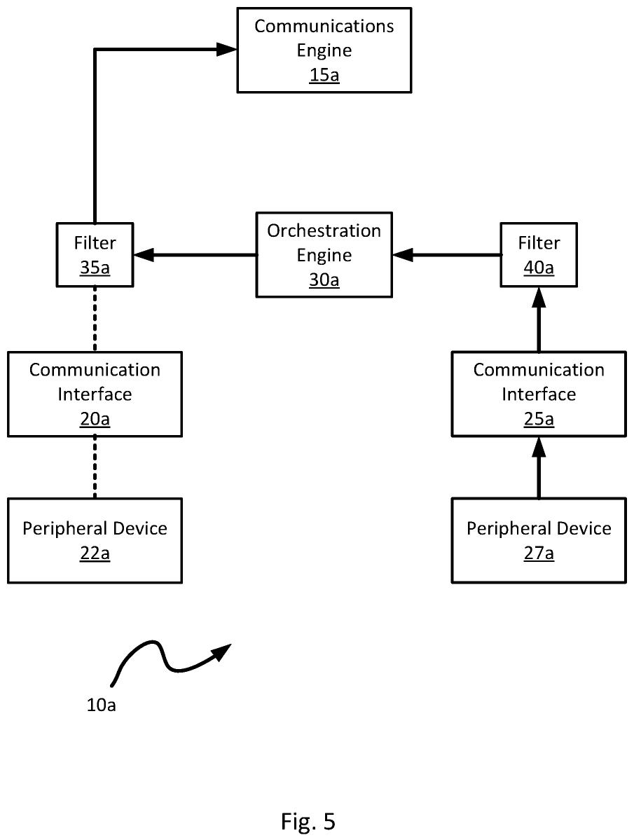

In the present example, the peripheral device 27a has the filter 40a installed. Similar to the filter 35a, the filter 40a may be a driver that is to control the peripheral device 27a in general. Referring to FIG. 5, the filter 40a may intercept Human Interface Device commands that are inbound from the peripheral device 27a to the unified communications client. Since the peripheral device 27a is not connected to the unified communications client, and command received at the peripheral device 27a may not be sent forward to the communications engine 15a. However, upon intercepting the Human Interface Device command from the peripheral device 27a with the filter 40a, the command is sent to the orchestration engine 30a which may forward the command to the unified communications client running on the communications engine via the filter 35a. From the point of view of the unified communications client, the command from the peripheral device 27a would appear to have been received from the peripheral device 22a such that no additional modifications are needed to either the Human Interface Device protocol or the unified communications client. Accordingly, although the peripheral device 27a is not in communication with the unified communications client using the Human Interface Device protocols, the peripheral device 27a will be able to receive the commands from a user in a similar manner as the peripheral device 22a. The peripheral device 27a will therefore be synchronized with the peripheral device 22a.

In addition, the filter 35a and the filter 40a may be used to detect the presence of the peripheral device 22a and the peripheral device 27a, respectively. Accordingly, upon the detection of the addition or removal of the peripheral device 22a or the peripheral device 27a, the information may be forwarded to the orchestration engine 30a which may adjust the manner by which the Human Interface Device commands are broadcasted. The manner by which the presence of the peripheral device 22a or the peripheral device 27a is detected is not particularly limited. For example, the filter 35a and the filter 40a may send periodic status checks to the communication interface 20a or the communication interface 25a to determine whether a peripheral device is connected.

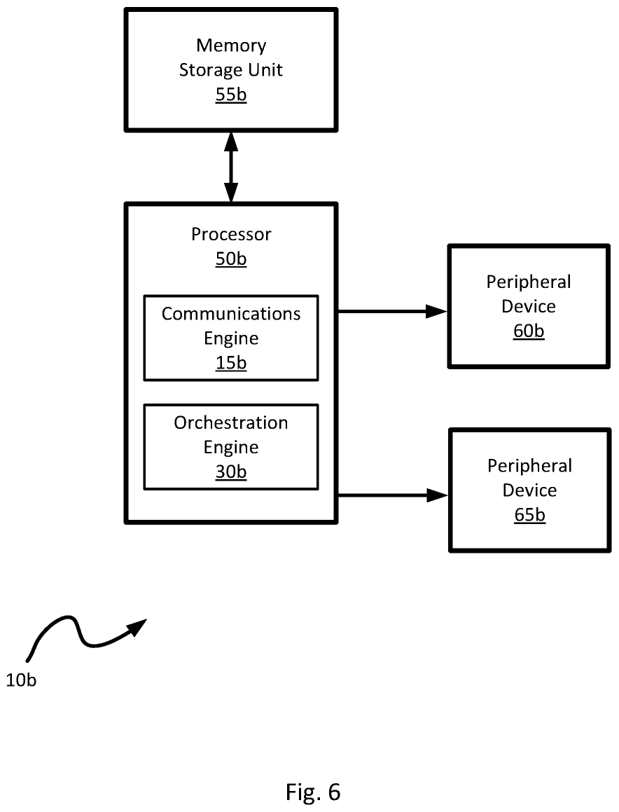

Referring to FIG. 6, another example of an apparatus to orchestrate commands between an application and peripheral devices is shown at 10b. Like components of the apparatus 10b bear like reference to their counterparts in the apparatus 10a, except followed by the suffix “b”. In the present example, the apparatus 10b includes a processor 50b, a memory storage unit 55b, and a first peripheral device 60b, and a second peripheral device 65b.

In the present example, the processor 50b may include a central processing unit (CPU), a microcontroller, a microprocessor, a processing core, a field-programmable gate array (FPGA), or similar. The processor 50b and memory storage unit 55b may cooperate to execute various instructions. The processor 50b maintains and operates a communications engine 15b to run an application such as the unified communications client. In addition, the processor 50b may operate an orchestration engine 30b to orchestrate commands and data between communications engine 15b, and the peripheral device 60b and the peripheral device 65b.

The processor 50b is also to control the peripheral device 60b and the peripheral device 65b. In particular, the processor 50b may send instructions to the peripheral device 60b and the peripheral device 65b to receive the user input and data. For example, the processor 50b may receive and send commands between unified communications client, the peripheral device 60b and the peripheral device 65b using a Human Interface Device protocol.

The memory storage unit 55b is coupled to the processor 50b and may include a non-transitory machine-readable storage medium that may be any electronic, magnetic, optical, or other physical storage device. The non-transitory machine-readable storage medium may include, for example, random access memory (RAM), electrically-erasable programmable read-only memory (EEPROM), flash memory, a storage drive, an optical disc, and the like. The memory storage unit 55b may also be encoded with executable instructions to operate the peripheral device 60b and the peripheral device 65b and other hardware in communication with the processor 50b. In other examples, it is to be appreciated that the memory storage unit 55b may be substituted with a cloud-based storage system.

The memory storage unit 55b may also store an operating system that is executable by the processor 50b to provide general functionality to the apparatus 10, for example, functionality to support various applications such as a user interface to access various features of the apparatus 10b. Examples of operating systems include Windows™, macOS™, iOS™, Android™, Linux™, and Unix™. The memory storage unit 55b may additionally store applications that are executable by the processor 50b to provide specific functionality to the apparatus 10b, such as those described in greater detail below.

The memory storage unit 55b may also store additional executable instructions for the operation of the apparatus 10b. In the present example, the executable instructions may include a set of instructions for the processor 50b to run in order to operate the communications engine 15b and the orchestration engine 30b.

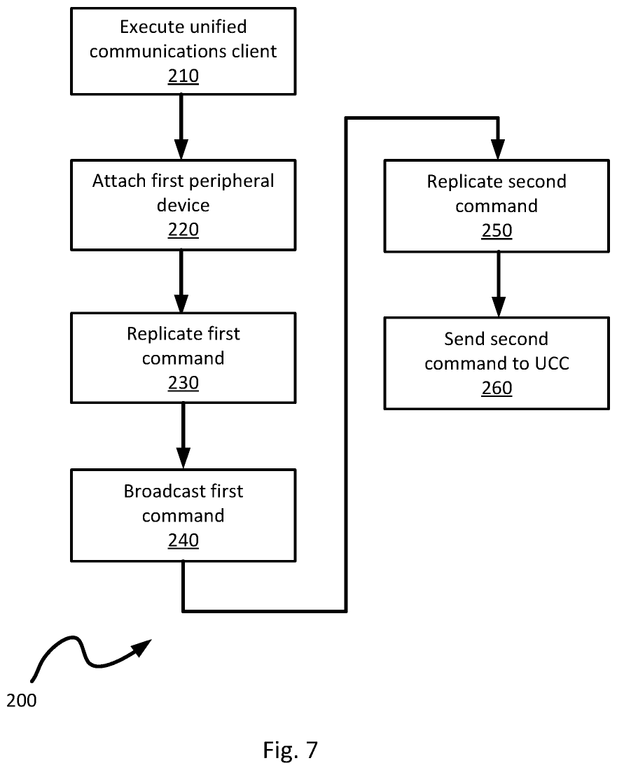

Referring to FIG. 7, a flowchart of a method of orchestrating commands between an application and peripheral devices is shown at 200. In order to assist in the explanation of method 200, it will be assumed that method 200 may be performed with the apparatus 10b. Indeed, the method 200 may be one way in which apparatus 10b may be configured to interact with an external device (not shown). Furthermore, the following discussion of method 200 may lead to a further understanding of the apparatus 10b and its various components. Furthermore, it is to be emphasized, that method 200 may not be performed in the exact sequence as shown, and various blocks may be performed in parallel rather than in sequence, or in a different sequence altogether.

Beginning at block 210, the processor 50b is to execute an application, such as a unified communications client, on the communications engine 15b. The communications engine 15b is to generally communicate with an external device operated by another user. For example, the unified communications client may establish a communication link with a second user via a standard for of communication, such as a telephone call.

Block 220 comprises attaching the peripheral device 60b to the unified communications client. In the present example, the unified communications client may communicate with a single peripheral device using the Human Interface Device protocol. The attachment of the peripheral device 60b may be predetermined either by the user or based on a priority list of devices. In other examples, the peripheral device may be attached in response to a triggering event, such as a selection by an input at the peripheral device 60b. The selection of the peripheral device 60b is not particularly limited and in some examples, the peripheral device 65b may be attached to the unified communications client.

Block 230 comprises replicating a command from the unified communications client to the peripheral device 60b. As noted above, since the peripheral device 60b is attached to the unified communications client via the Human Interface Device protocol, the unified communications client will not be able to communicate with other peripheral devices using the same protocol. In the present example, the command sent to the peripheral device 60b may be intercepted with a filter, replicated, and transmitted to the orchestration engine 30b. Furthermore, the filter may be a driver associated with the peripheral device 60b. The manner by which the command is transmitted to the orchestration engine 30b is not limited and may involve a pushing or pulling process.

In block 240, the replicated command generated at block 230 is broadcasted to other peripheral devices. In this example, the only other peripheral device is the peripheral device 65b. In other examples, additional peripheral devices may receive the replicated command. For example, if the original command from the unified communications client is to alert the peripheral device 60b that a telephone call is incoming, block 240 may alert the peripheral device 65b as well.

Block 250 comprises replicating a command from the peripheral device 65b. In this example, since the peripheral device 65b is not in direct communication with the unified communication client, the peripheral device cannot send a command to the unified communication client. Instead, the command may be replicated by a filter to transmit to the orchestration engine 30b which may subsequently send the command to the unified communications client in block 260. The manner by which the command from the peripheral device 65b is transmitted to the orchestration engine 30b via the filter is not limited and may involve a pushing or pulling process.

Accordingly, when the user is alerted to the telephone call, instead of answering the call with the peripheral device 60b, the user may use the peripheral device 65b since the command will be routed through the orchestration engine 30b to the unified communications client while using the Human Interface Device protocol such that additional development to add backdoors to the unified communications client may be omitted.

It should be recognized that features and aspects of the various examples provided above may be combined into further examples that also fall within the scope of the present disclosure.

What is claimed is:

1. An apparatus comprising:
an application engine to execute an application;
a first communication interface to communicate with a first peripheral device;
a second communication interface to communicate with a second peripheral device; and
an orchestration engine in communication with the application engine, the first communication interface, and the second communication interface,
wherein the orchestration engine is to receive an application command from the application and to broadcast the application command to the first peripheral device and the second peripheral device, and
wherein the orchestration engine is to receive a device command from the first peripheral device or the second peripheral device, wherein the device command is to control the application.

2. The apparatus of claim 1, wherein the application is to provide user communication with an external device.

3. The apparatus of claim 2, wherein the application is a unified communications client.

4. The apparatus of claim 1, wherein the first peripheral device is to establish a direct connection to the application in response to a triggering event.

5. The apparatus of claim 4, wherein the triggering event is a user input received at the first peripheral device.

6. The apparatus of claim 5, further comprising a filter driver to be installed over the first peripheral device, wherein the filter driver is to replicate one of the application command or the device command of the first peripheral device to generate a replicated command.

7. The apparatus of claim 6, wherein the filter driver pushes the replicated command to the orchestration engine.

8. The apparatus of claim 5, further comprising a filter driver to be installed over the second peripheral device, wherein the filter driver is to replicate the device command of the second peripheral device to generate a replicated command.

9. The apparatus of claim 8, wherein the filter driver pushes the replicated command to the orchestration engine.

10. A non-transitory machine-readable storage medium encoded with instructions executable by a processor of an electronic device to:
execute an application, wherein the application is to provide communications between users;
attach a first peripheral device to application in response to a triggering event;
replicate a first command between the first peripheral device and the application to generate a first replicated command;
broadcast the first replicated command to a second peripheral device;
replicate a second command from a second peripheral device to the application to generate a second replicated command; and
send the second replicated command to the application.

11. The non-transitory machine-readable storage medium of claim 10, wherein the triggering event is an input received at the first peripheral device.

12. The non-transitory machine-readable storage medium of claim 10, wherein the instructions when executed further cause the processor to transmit the first replicated command and the second replicated command to an orchestration engine from a filter driver.

13. An apparatus comprising:
a communications engine to execute a unified communications client;
a first peripheral device attached to the unified communications client via a Human Interface Device protocol;
a second peripheral device to receive user input; and
an orchestration engine in communication with the communications engine, the first peripheral device, and the second peripheral device,
wherein the orchestration engine is to receive an application command from the unified communications client and to send the application command to the second peripheral device, and
wherein the orchestration engine is to receive a device command from the second peripheral device and to send the device command to the unified communications client via the Human Interface Device protocol.

14. The apparatus of claim 13, wherein the application command is to control a status indicator.

15. The apparatus of claim 13, wherein the device command is to control a volume.
